(19) United States
(12) Patent Application Publication
(10) Pub. No.: US 2023/0126063 A1
(43) Pub. Date: Apr. 27, 2023

(54) METHOD FOR PROCESSING DATA AND COMPUTER DEVICE

(71) Applicant: BEIJING DAJIA INTERNET INFORMATION TECHNOLOGY CO., LTD., Beijing (CN)

(72) Inventors: Bingqing SUN, Beijing (CN); Qiuyue WEN, Beijing (CN); Chenhong LIU, Beijing (CN); Xuan WANG, Beijing (CN); Xin YE, Beijing (CN)

(21) Appl. No.: 17/857,902

(22) Filed: Jul. 5, 2022

(30) Foreign Application Priority Data
Oct. 22, 2021 (CN) 202111235350.2

(51) Int. Cl. G06Q 30/06; G06V 10/74; H04N 21/2187; H04N 21/478; G06F 16/532; G06F 16/9038; G06K 7/14

(52) U.S. Cl. CPC G06Q 30/0643; G06V 10/761; H04N 21/2187; H04N 21/47815; G06F 16/532; G06F 16/9038; G06K 7/1417; G06K 7/1413

(57) ABSTRACT

Provided is a method for processing data, which belongs to the field of Internet technologies. The method includes: providing an item identification function in a live streaming room; acquiring item information based on the item identification function; triggering a server to query a matched target item based on the item information; receiving the target item returned by the server; displaying the target item and a post control in the live streaming room; and adding the target item into an item list of the live streaming room in response to a trigger operation on the post control.

### CROSS-REFERENCE TO RELATED APPLICATION

This application is based on and claims priority to Chinese Patent Application No. 202111235350.2, filed on Oct. 22, 2021, the disclosure of which is herein incorporated by reference in its entirety.

### TECHNICAL FIELD

The present disclosure relates to the field of Internet technologies, and in particular, to a method for processing data and a computer device.

### BACKGROUND

As live streaming and e-commerce technologies develop, they are integrated more and more tightly. An anchor can post various items in a live streaming room to attract audiences to buy the items in the live streaming room through introduction of the items during live streaming.

### SUMMARY

The present disclosure provides a method for processing data and a computer device. The technical solutions of the present disclosure are as follows.

According to an aspect of the present disclosure, a method for processing data is provided. The method is performed by a terminal and includes: determining item information by identifying an item based on an item identification function provided in a live streaming room; sending an item query request to a server based on the item information, wherein the item query request is configured to query a target item matching the item information from a set of items associated with the live streaming room; receiving the target item returned by the server based on the item query request; displaying the target item and a post control, wherein the post control is configured to post the target item; and adding the target item into an item list of the live streaming room in response to a trigger operation on the post control.

According to another aspect of the present disclosure, a method for processing data is provided. The method is performed by a server and includes: receiving an item query request sent by a terminal based on an item identification function provided in a live streaming room, wherein the item identification function is configured to determine item information based on item identification, and the item query request carries the item information; querying, based on the item information, a target item matching the item information from a set of items associated with the live streaming room; sending the target item to the terminal to trigger the terminal to display the target item and a post control, wherein the post control is configured to post the target item; and adding the target item into an item list of the live streaming room in response to receiving a post request sent by the terminal for the target item, wherein the post request is sent by the terminal in response to a trigger operation on the post control.

According to still another aspect of the present disclosure, a computer device is provided. The computer device includes one or more processors, and a memory for storing one or more program codes executable by the processors. The one or more program codes, when executed by the processors, cause the processors to perform: determining item information by identifying an item based on an item identification function provided in a live streaming room; sending an item query request to a server based on the item information, wherein the item query request is configured to query a target item matching the item information from a set of items associated with the live streaming room; receiving the target item returned by the server based on the item query request, and displaying the target item and a post control, wherein the post control is configured to post the target item; and adding the target item into an item list of the live streaming room in response to a trigger operation on the post control.

### BRIEF DESCRIPTION OF THE DRAWINGS

FIG. 1 is a schematic diagram of an implementation environment of a method for processing data according to some embodiments of the present disclosure;

FIG. 2 is a flowchart of a method for processing data according to some embodiments of the present disclosure;

FIG. 3 is a flowchart of a method for processing data according to some embodiments of the present disclosure;

FIG. 4 is a flowchart of a method for processing data according to some embodiments of the present disclosure;

FIG. 5 is a schematic diagram of an item list page according to some embodiments of the present disclosure;

FIG. 6 is a schematic diagram of a page provided with an item identification function according to some embodiments of the present disclosure;

FIG. 7 is a schematic diagram of an item detail page according to some embodiments of the present disclosure;

FIG. 8 is a schematic diagram of displaying a plurality of target items according to some embodiments of the present disclosure;

FIG. 9 is a schematic diagram of an item list page according to some embodiments of the present disclosure;

FIG. 10 is a flowchart of posting an item according to some embodiments of the present disclosure;

FIG. 11 is a flowchart of posting an item according to some embodiments of the present disclosure;

FIG. 12 is a block diagram of an apparatus for processing data according to some embodiments of the present disclosure;

FIG. 13 is a block diagram of an apparatus for processing data according to some embodiments of the present disclosure;

FIG. 14 is a block diagram of a terminal according to some embodiments of the present disclosure; and

FIG. 15 is a block diagram of a server according to some embodiments of the present disclosure.

### DETAILED DESCRIPTION

Data or information in the present disclosure may be authorized by a user or sufficiently authorized by all parties.

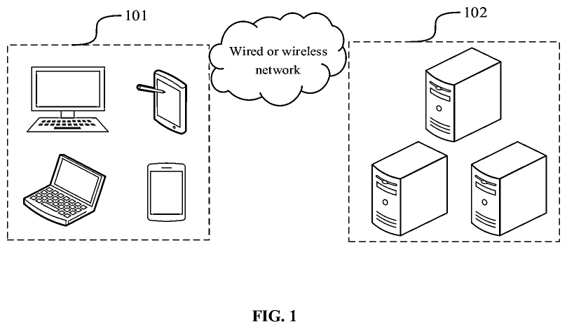

FIG. 1 is a schematic diagram of an implementation environment of a method for processing data according to some embodiments of the present disclosure. Referring to FIG. 1, the implementation environment includes a terminal 101 and a server 102.

The terminal 101 corresponds to anchor's account in a live streaming room. In some embodiments, the terminal 101 is at least one of a smart phone, a smart watch, a desktop computer, a portable computer, a virtual reality terminal, an augmented reality computer, a wireless terminal, a laptop portable computer, and the like. The terminal 101 has a communication function, and can access a wired or wireless network. The terminal 101 refers to one of a plurality of terminals. This embodiment is only described by taking the terminal 101 as an example. Those skilled in the art may understand that there may be more or fewer terminals.

In some embodiments, an application program having a live streaming function runs on the terminal 101. Exemplarily, the anchor can post various items in the live streaming room by performing operations on the terminal 101, that is, add items into an item list of the live streaming room to make the items tradable; and then attract audiences to buy the items in the live streaming room through introduction of the items during live streaming. It should be noted that the live streaming room of the anchor is associated with a set of items. The set of items includes a plurality of items preset by the anchor and information related to the plurality of items. In some embodiments, the anchor can add a new item and information related to the new item into the set of items by performing operations on the terminal 101.

In the related art, to post an item in the live streaming room, an anchor needs to query an item from a set of items associated with the anchor through page flip or search for the item based on an item title to acquire a plurality of acquired items, and then search for the item from the plurality of acquired items through page flip, and post the item that the anchor wants to post.

Based on this, some embodiments of the present disclosure provide a method for processing data, and in particular, to a method in which an item is posted fast by matching the item based on item identification. In the embodiments of the present disclosure, a terminal 101 is configured to: determine item information by identifying an item based on an item identification function provided in a live streaming room; send an item query request to a server 102 based on the item information, such that the server is triggered to query a target item matching the item information from a set of items associated with the live streaming room; receive the target item returned by the server 102 based on the item query request; display the target item and a post control; and add the target item into an item list of the live streaming room in response to a trigger operation on the post control.

The server 102 is a backend server of an application program having a live streaming function. The server 102 and the terminal 101 are connected directly or indirectly through wired or wireless communication, which is not limited in the embodiments of the present disclosure. In some embodiments, the server 102 is an independent physical server, a server cluster including a plurality of physical servers, a distributed file system, or a cloud server providing cloud services, cloud databases, cloud computing, cloud functions, cloud storage, network services, cloud communication, middleware services, domain name services, security services, a content delivery network (CDN), big data, and artificial intelligence platforms, and other basic cloud computing services. In some embodiments, there may be more or fewer servers 102, which is not limited in the embodiments of the present disclosure. In addition, in some embodiments, the server 102 further includes another functional server, thereby providing more comprehensive and diversified services.

In the embodiments of the present disclosure, the server 102 is configured to: receive an item query request sent by a terminal 101 based on an item identification function provided in a live streaming room; query, based on the item information carried in the item query request, a target item matching the item information from a set of items associated with the live streaming room; send the target item to the terminal 101 to trigger the terminal 101 to display the target item and a post control; and add the target item into an item list of the live streaming room in response to receiving a post request for the target item.

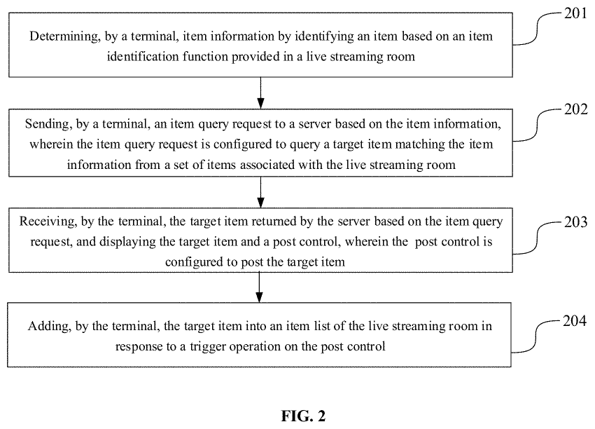

FIG. 2 is a flowchart of a method for processing data according to some embodiments of the present disclosure. As shown in FIG. 2, the method is performed by a terminal and includes the following processes.

In 201, the terminal determines item information by identifying an item based on an item identification function provided in a live streaming room.

In 202, the terminal sends an item query request to a server based on the item information, wherein the item query request is configured to query a target item matching the item information from a set of items associated with the live streaming room.

In 203, the terminal receives the target item returned by the server based on the item query request, and displays the target item and a post control, wherein the post control is configured to post the target item.

In 204, the terminal adds the target item into an item list of the live streaming room in response to a trigger operation on the post control.

According to the technical solutions in the embodiments of the present disclosure, an item identification function is provided in a live streaming room; item information is acquired fast based on the item identification function; a server is triggered to query a matched target item based on the item information; in the case that the target item from the server is received, the target item and a post control are displayed in the live streaming room; and the target item can be added into an item list of the live streaming room fast in response to a trigger operation on the post control. According to the above method in which an item is posted fast by matching the item based on the item identification function, the terminal does not need to display all items to be posted, such that a user can query an item, thereby saving computing resources of the terminal. In addition, the user does not need to perform a plurality of page flip operations to query the item, such that an operation path for acquiring the item is shortened, and human-computer interaction efficiency and user's experience are improved.

In some embodiments, determining the item information by identifying the item based on the item identification function provided in the live streaming room includes:

acquiring item information corresponding to a graphic code of an item by scanning the graphic code a target position based on a graphic code scanning function provided in the live streaming room;

acquiring a picture containing a serial number of an item by shooting the serial number at a target position based on a shooting function provided in the live streaming room, and acquiring item information corresponding to the serial number by identifying the picture containing the serial number; or

acquiring a picture containing a serial number of an item by shooting the serial number at a target position based on a shooting function provided in the live streaming room, and acquiring item information corresponding to the serial number by identifying the picture containing the serial number.

In some embodiments, the live streaming room includes a slide control; and

the method further includes:

in the case of scanning based on the graphic code scanning function, switching the graphic code scanning function to the shooting function in response to a first slide operation on the slide control; or

in the case of shooting based on the shooting function, switching the shooting function to the graphic code scanning function in response to a second slide operation on the slide control.

In some embodiments, displaying the target item includes:

in the case of present a single target item, displaying an item detail page of the target item, wherein the item detail page includes detailed information of the target item; or

in the case of presenting a plurality of target items, displaying the plurality of target items in the form of a list.

In some embodiments, adding the target item into the item list of the live streaming room in response to the trigger operation on the post control includes:

in the case of presenting a plurality of target items, determining a selected target item in response to a select operation for at least one of the target items; and

adding the selected target item into the item list of the live streaming room in response to the trigger operation on the post control.

In some embodiments, the live streaming room includes an item identification control configured to trigger the item identification function; and the method further includes:

displaying a page provided with the item identification function in response to a trigger operation on the item identification control.

In some embodiments, the method further includes:

displaying the item identification control prominently in the live streaming room.

In some embodiments, the method further includes:

displaying the item identification control in an item list page of the live streaming room, wherein the item list page is configured to display at least one item that is traded in the live streaming room.

In some embodiments, the method further includes:

in the case that the target item is added successfully, jumping to the item list page of the live streaming room; and

displaying the target item on the item list page.

In some embodiments, displaying the target item on the item list page includes:

displaying the target item in a target region of the item list page.

In some embodiments, the method further includes:

in the case that the item information fails to be determined based on the item identification function, displaying identification prompt information in the live streaming room, wherein the identification prompt information is configured to indicate identification failure;

in the case that a network fault is present, displaying network prompt information in the live streaming room, wherein the network prompt information is configured to prompt the network fault; or

in the case that there's no target item matching the item information, displaying query prompt information in the live streaming room, wherein the query prompt information is configured to indicate that there's no target item matching the item information.

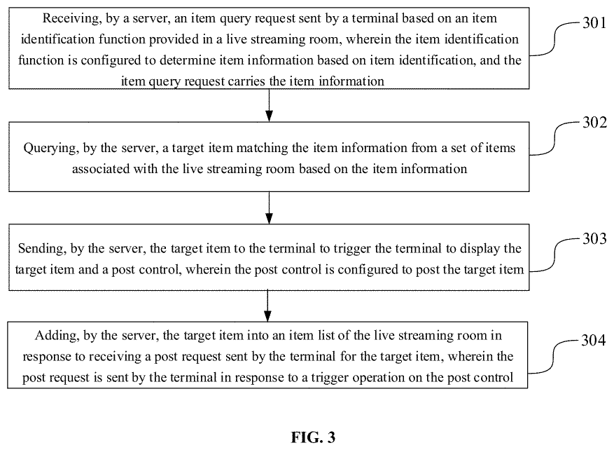

FIG. 3 is a flowchart of a method for processing data according to some embodiments of the present disclosure. As shown in FIG. 3, the method is performed by a server and includes the following processes:

In 301, a server receives an item query request sent by a terminal based on an item identification function provided in a live streaming room, wherein the item identification function is configured to determine item information based on item identification; and the item query request carries the item information.

In 302, the server queries, based on the item information, a target item matching the item information from a set of items associated with the live streaming room.

In 303, the server sends the target item to the terminal to trigger the terminal to display the target item and a post control, wherein the post control is configured to post the target item.

In 304, the server adds the target item into an item list of the live streaming room in response to receiving a post request sent by the terminal for the target item, wherein the post request is sent by the terminal in response to a trigger operation on the post control.

According to the technical solutions in the embodiments of the present disclosure, an item identification function is provided in a live streaming room; item information is acquired fast based on the item identification function; a server is triggered to query a matched target item based on the item information; the target item and a post control are displayed in the live streaming room; and the target item can be added into an item list of the live streaming room fast in response to a trigger operation on the post control. According to the above method in which an item is posted fast by matching the item based on the item identification function, a user can find the item fast without performing a plurality of page flip operations, such that an operation path for acquiring the item is shortened, and human-computer interaction efficiency and user's experience are improved. In addition, the server does not need to send all items to be posted to the terminal, such that an amount of data interacted between the terminal and the server is decreased, and data processing efficiency is improved.

In some embodiments, the item query request carries item information corresponding to an item picture; and

querying, based on the item information, the target item matching the item information from the set of items associated with the live streaming room includes:

determining, based on the item information that corresponds to the item picture and is carried by the item query request, a target item matching the item picture from the set of items, wherein the set of items includes item pictures corresponding to a plurality of items.

In some embodiments, determining, based on the item information that corresponds to the item picture and is carried by the item query request, the target item matching the item picture from the set of items includes:

determining a picture similarity between the item picture and each of the item pictures that correspond to the plurality of items and are contained in the set of items; and

determining an item corresponding to an item picture with the picture similarity satisfying a similarity condition as the target item.

In some embodiments, the item query request carries item information corresponding to a serial number of an item; and

querying, based on the item information, the target item matching the item information from the set of items associated with the live streaming room includes:

determining, based on the item information that corresponds to the serial number of the item and is carried in the item query request, a target item matching the serial number from the set of items, wherein the set of items includes serial numbers corresponding to a plurality of items.

In some embodiments, the method further includes:

in the case of presenting a single target item, returning first prompt information to the terminal, wherein the first prompt information is configured to prompt the terminal to display an item detail page of the target item, and the item detail page includes detailed information of the target item; or

in the case of presenting a plurality of target items, returning second prompt information to the terminal, wherein the second prompt information is configured to prompt the terminal to display the plurality of target items in the form of a list.

In some embodiments, the method further includes:

in the case that a network fault is present, returning network prompt information to the terminal, wherein the network prompt information is configured to prompt the network fault; or

in the case that there's no target item matching the item information, returning query prompt information to the terminal, wherein the query prompt information is configured to indicate that there's no target item matching the item information.

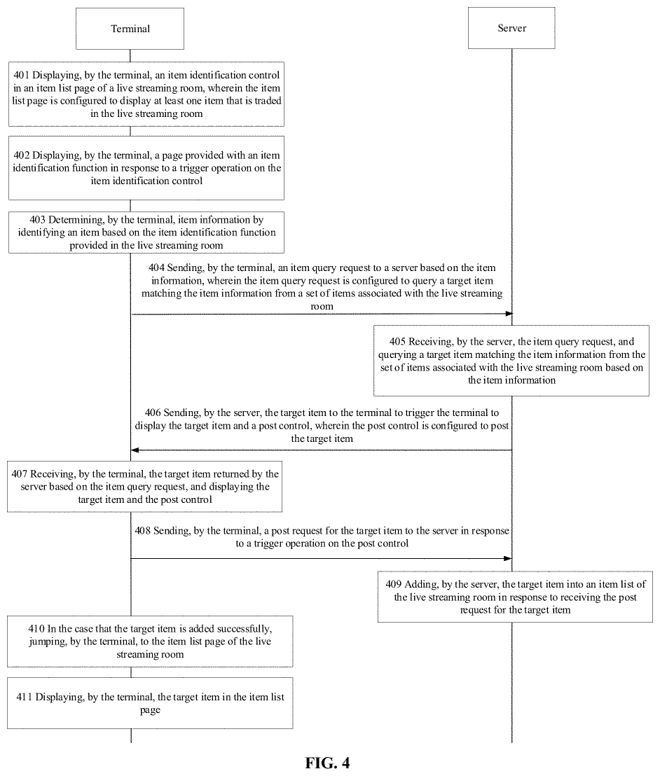

FIG. 2 and FIG. 3 show merely basic processes of the present disclosure. The following further describes the solution of the present disclosure based on a specific embodiment. FIG. 4 is a flowchart of a method for processing data according to some embodiments of the present disclosure. Referring to FIG. 4, an interaction between a terminal and a server is used as an example for description. The method includes the following processes.

In 401, a terminal displays an item identification control in an item list page of a live streaming room, wherein the item list page is configured to display at least one item that is traded in the live streaming room.

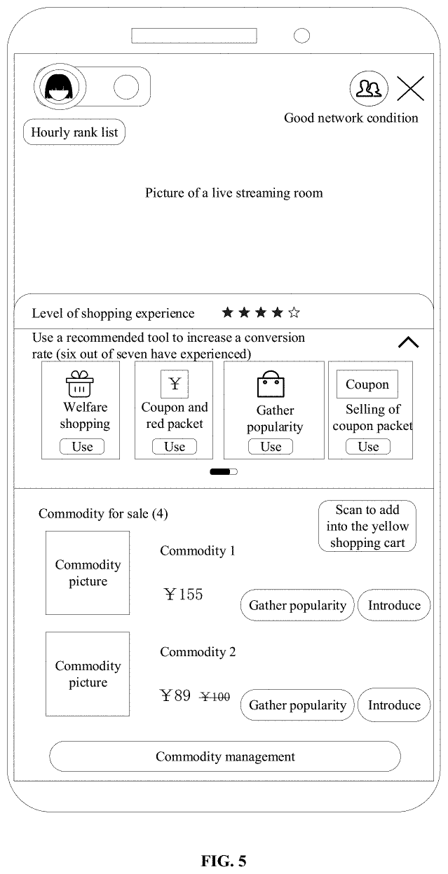

In this embodiment of the present disclosure, the live streaming room is provided with an item identification control configured to trigger the item identification function. Exemplarily, FIG. 5 is a schematic diagram of an item list page according to some embodiments of the present disclosure. Referring to FIG. 5, the item list page is a commodity list page shown in FIG. 5 (also referred to as a yellow shopping cart page); and the item identification control is a “Scan to add into the yellow shopping cart” control shown in FIG. 5.

In some embodiments, the terminal displays the item identification control in a navigation bar of the item list page. Exemplarily, referring to FIG. 5, the “Scan to add into the yellow shopping cart” control is displayed in the navigation bar of the commodity list page. Therefore, an amount of information displayed on the item list page is increased by displaying the item identification control on the item list page.

In some embodiments, the terminal displays function prompt information of the item identification control in the live streaming room. A corresponding process includes: in the case that an account logged in the terminal accesses the item list page for the first time, displaying, by the terminal, the function prompt information of the item identification control. In some embodiments, the terminal displays the function prompt information of the item identification control in response to a hover operation in a region where the item identification control is disposed.

The function prompt information is configured to prompt a trigger function of the item identification control. Exemplarily, the function prompt information is “Scan a commodity to post it into a yellow shopping cart fast”. The hover operation is hovering a command input tool such as a mouse, a stylus, or a finger above a region in a display screen without clicking. In some embodiments, the terminal displays, in the form of a bubble bomb window, the function prompt information of the item identification control in the region where the item identification control is disposed.

In some embodiments, in the case that the number of display times of the function prompt information of the item identification control reaches a first value, the terminal stops displaying the function prompt information of the item identification control. The first value is a preset value, for example, 3. In some other embodiments, in the case that displaying duration of the function prompt information of the item identification control reaches first duration, the terminal stops displaying the function prompt information of the item identification control. The first duration is preset duration, for example, 3 seconds.

In some embodiments, the terminal displays the item identification control prominently in the live streaming room to prompt a user to trigger the item identification function through the item identification control. A corresponding process includes: displaying, by the terminal, the item identification control in a prominently displayed form in the live streaming room. In some embodiments, in the case that the account logged in the terminal accesses the item list page for the first time, the terminal displays the item identification control in the prominently displayed form. Exemplarily, the prominently displayed form includes: jittering, highlighted, text-coarsened, bordered, shadowed, dynamic effect—added, or the like. For example, taking the prominently displayed form being jittering as an example, the terminal displays the item identification control in a jittering form on the item list page. It should be understood that the above example is only illustrative, and implementation of the prominently displayed form is not limited in these embodiments of the present disclosure. All displaying modes that are used for displaying a control in a prominently displayed fashion and prompting a user can be used as the above prominently displayed form.

In some embodiments, taking the prominently displayed form being jittering as an example, in the case that the number of jittering times of the item identification control reaches a second value, the terminal stops displaying the item identification control in a jittering form. The second value is a preset value, for example, 2. In some other embodiments, in the case that jittering duration of the item identification control reaches second duration, the terminal stops displaying the item identification control in a jittering form. The second duration is preset duration, for example, 5 seconds.

In this embodiment, the item identification control is displayed prominently, such that a user can be prompted to trigger the item identification function through the item identification control, and human-computer interaction efficiency is improved.

In 402, the terminal displays a page provided with an item identification function in response to a trigger operation on the item identification control.

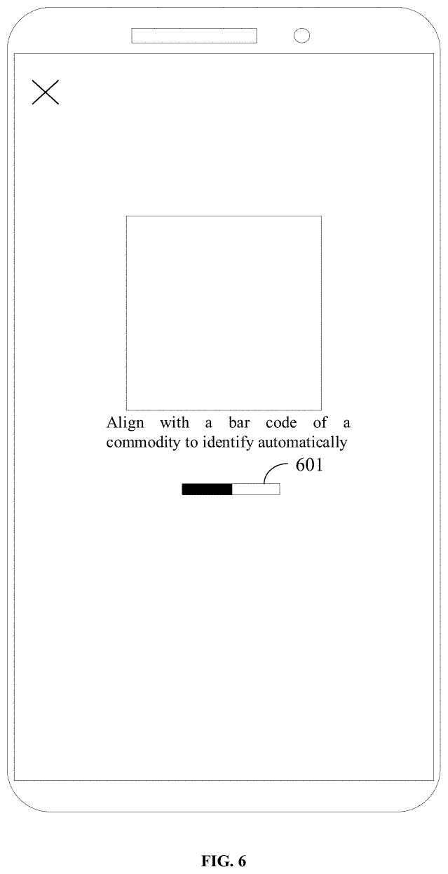

Exemplarily, FIG. 6 is a schematic diagram of a page provided with an item identification function according to some embodiments of the present disclosure. In the case that the “Scan to add into the yellow shopping cart ” control shown in FIG. 5 is clicked, the terminal can be triggered to display the page provided with the item identification function shown in FIG. 6. In the embodiments, the item identification control is provided, such that the user can trigger the displaying of the page provided with the item identification function through the item identification control. Then, item information can be acquired based on the item identification function, which improves human-computer interaction efficiency, and further improves efficiency of acquiring the item information.

In some embodiments, the item identification function provided in the live streaming room includes a graphic code scanning function and a shooting function. The graphic code scanning function is configured to scan a graphic code of an item. The shooting function is configured to shoot an item picture or a picture containing the item information. Exemplarily, referring to FIG. 6, a page provided with the graphic code scanning function is a scanning page shown in FIG. 6.

In some embodiments, the live streaming room includes a slide control; and a corresponding identification function can be triggered based on a slide operation on the slide control. A corresponding process includes: in the case of scanning based on the graphic code scanning function, switching, by the terminal, the graphic code scanning function to the shooting function in response to a first slide operation on the slide control; or in the case of shooting based on the shooting function, switching, by the terminal, the shooting function to the graphic code scanning function in response to a second slide operation on the slide control. Exemplarily, referring to FIG. 6, the slide control is “Slide control 601” shown in FIG. 6. For example, the first slide operation is leftward; and the second slide operation is rightward. Accordingly, the terminal switches the graphic code scanning function to the shooting function in response to the leftward slide operation on the slide control; or the terminal switches the shooting function to the graphic code scanning function in response to the rightward slide operation on the slide control. In this way, switching of the item identification function can be performed through the slide operation on the slide control, which improves flexibility of switching the item identification function.

In 403, the terminal determines item information by identifying an item based on the item identification function provided in the live streaming room.

In some embodiments, the item identification function provided in the live streaming room includes a graphic code scanning function and a shooting function. Processes of determining the item information based on the graphic code scanning function and the shooting function are respectively described below.

(403A): in some embodiments, the item identification function provided in the live streaming room is the graphic code scanning function; and a process in which the terminal identifies the item based on the graphic code scanning function includes: acquiring, by the terminal, item information corresponding to a graphic code of an item by scanning the graphic code at a target position based on the graphic code scanning function provided in the live streaming room.

The graphic code is a graph used to carry data information. The data information can be processed automatically through automatic identification of a scanning device. For example, commodity information can be acquired by scanning a bar code of the commodity. In some embodiments, the graphic code is a quick response code (QR code), a visual identification code (VR code), or a bar code. The graphic code carries item information, for example, the item information corresponding to the graphic code is an item name, an item identity (ID), or the like that is carried in the graphic code. The target position is any position in entity space. For example, in the case that an item is disposed on a desk, the target position is a position where the desk is disposed. This is not limited in the present disclosure. Exemplarily, the graphic code of the item at the target position is a graphic code printed on an item entity, or a graphic code that is of the item and printed on paper.

(403B): in some embodiments, the item identification function provided in the live streaming room is the shooting function; and a process in which the terminal identifies the item based on the shooting function includes any one of the followings:

Case 1: The terminal acquires an item picture of an item by shooting the item at a target position based on the shooting function provided in the live streaming room, and acquires item information corresponding to the item picture by identifying the item picture.

The item at the target position is an item entity. In this embodiment, the item information corresponding to the item picture can be acquired fast through picture identification on the item picture. In some embodiments, the item information corresponding to the item picture is a picture feature of the item picture.

Case 2: The terminal acquires a picture containing a serial number of an item by shooting the serial number at a target position based on the shooting function provided in the live streaming room, and acquires item information corresponding to the serial number by identifying the picture containing the serial number.

The serial number of the item at the target position is a serial number printed on the item entity, a serial number printed on paper, or a serial number written on paper. In this embodiment, the item information corresponding to the serial number of the item can be acquired fast through character identification on the picture containing the serial number. In some embodiments, the item information corresponding to the serial number of the item is the serial number information of the item.

In the above embodiments, the item information can be acquired fast by either acquiring the item information corresponding to the graphic code through the graphic code scanning function or acquiring the item picture or the item information corresponding to the serial number of the item through the shooting function, such that a user can find the item fast without performing a plurality of page flip operations, and human-computer interaction efficiency and user's experience are improved.

In some embodiments, in the case that the item information is determined based on the item identification function, the terminal performs 404. In some other embodiments, in the case that the item information is not determined based on the item identification function, the terminal displays identification prompt information in the live streaming room, wherein the identification prompt information is configured to indicate identification failure. In some embodiments, the terminal displays the identification prompt information on the page provided with the item identification function. Exemplarily, the identification prompt information is “Scanning fails”. In this way, an amount of information displayed in the live streaming room is increased by displaying the identification prompt information, such that the user can acquire an identification status of the item in time.

In some embodiments, in the case that a network fault is present, the server returns network prompt information to the terminal. Accordingly, in the case that a network fault is present, the terminal displays network prompt information in the live streaming room, wherein the network prompt information is configured to prompt the network fault. In some embodiments, the server displays the network prompt information on the page provided with the item identification function. Exemplarily, the network prompt information is “Network error: Connection timed out”. In this way, an amount of information displayed in the live streaming room is increased by displaying the network prompt information, such that the user can acquire a status of a network in time.

In 404, the terminal sends an item query request to a server based on the item information, wherein the item query request is configured to query a target item matching the item information from a set of items associated with the live streaming room.

The item information is any one of the item information corresponding to the graphic code, the item information corresponding to the item picture, or the item information corresponding to the serial number of the item. In some embodiments, the set of items associated with the live streaming room is an item shelf of an anchor's account according to the live streaming room. For example, in the case that the item is commodity, the set of items is a commodity shelf of the anchor's account. Before this solution is performed, in the case that a new item is added into the set of items, the anchor can also input a graphic code or a serial number of the item, thereby providing convenience for a subsequent process of matching the item based on the graphic code or serial number.

In 405, the server receives the item query request, and queries, based on the item information, a target item matching the item information from a set of items associated with the live streaming room.

Based on the embodiment shown in 403 in which the item information is determined based on the graphic code scanning function or the shooting function, the determined item information is any one of the item information corresponding to the graphic code, the item information corresponding to the item picture, or the item information corresponding to the serial number of the item. Processes of matching the item information are described below based on the above three types of item information. There are the following three matching processes.

Process 1: The item query request carries the item information corresponding to the graphic code. The item information is an item name, an item ID, or the like. The set of items includes item information corresponding to a plurality of items. For example, in the case that the item information is the item name, a process in which the server queries the target item based on the item name includes: determining, by the server, a target item matching the item name by querying the set of items associated with the live streaming room based on the item name carried in the item query request from. For example, in the case that the item information is the item ID, a process in which the server queries the target item based on the item ID includes: determining, by the server, a target item matching the item ID by querying from the set of items associated with the live streaming room based on the item ID carried in the item query request.

Process 2: The item query request carries item information corresponding to an item picture; and the set of items includes item pictures corresponding to a plurality of items. Accordingly, a process in which the server queries the target item based on the item picture includes: determining, by the server, a target item matching the item picture by querying the set of items associated with the live streaming room based on the item information that corresponds to the item picture and is carried in the item query request.

In some embodiments, a process in which the server queries the target item based on the item picture includes: determining, by the server, a picture similarity between the item picture and each of the item pictures that correspond to the plurality of items and are contained in the set of items; and determining an item corresponding to an item picture with the picture similarity satisfying a similarity condition as the target item. In this way, the target item can be acquired fast by computing a picture similarity between a picture to be identified and each of a plurality of item pictures and then determining a matched item picture based on the picture similarity, such that efficiency of acquiring the target item is improved.

The picture similarity is a similarity between an item picture to be identified and each of a plurality of candidate pictures. For example, the item picture to be identified is the item picture acquired by shooting; and the plurality of candidate pictures are the item pictures that correspond to the plurality of items and are contained in the set of items. In some embodiments, the picture similarity is represented by a distance between a picture feature of the item picture to be identified and a picture feature of each of the plurality of candidate pictures. The picture feature is used for measuring a similarity between one picture and another picture. For example, the picture feature is represented by a vector. In some embodiments, the distance is a Euclidean distance, a cosine distance, a Hamming distance, or the like. It should be understood that a longer distance indicates a smaller picture similarity; and a shorter distance indicates a larger picture similarity.

Based on the embodiment described in the process 2, the item information corresponding to the item picture is a picture feature of the item picture. Accordingly, the server computes the picture similarity between the item picture and the item picture of each of the plurality of items based on the picture feature of the item picture and picture features of the item pictures that correspond to the plurality of items and are contained in the set of items; and then determine a matched item picture based on the picture similarity. In this embodiment, the terminal performs picture identification to acquire the picture features; and then the server performs an item matching process based on the picture features. In this way, processing content of the server is decreased, that is, processing efficiency of the server is improved.

In the above embodiments, the terminal performs picture identification to acquire the picture features; and then the server performs the item matching process based on the picture features. In some other embodiments, the server can perform both the picture identification process and the item matching process. A corresponding process includes: determining, by the server, the item information corresponding to the item picture by identifying the item picture based on the item picture carried in the item query request, and performing a subsequent process of determining a picture similarity based on the item information corresponding to the item picture. In some embodiments, the server uses a picture model to determine the picture similarity. A corresponding process includes: inputting, by the server, the item picture and the item pictures that correspond to the plurality of items and are contained in the set of items into the picture model; extracting the picture features of the item picture and the item pictures of the plurality of items through a feature extraction layer of the picture model; determining the picture similarity between the item picture and the item picture of each of the plurality of items through a convolutional layer of the picture model based on the picture features of the item picture and the item pictures of the plurality of items; and finally outputting the plurality of picture similarities.

In the above embodiments, the target item matching the item picture is acquired based on the item information corresponding to the item picture, such that the target item matching the item information can be acquired fast, and efficiency of acquiring the target item is improved.

Process 3: The item query request carries item information corresponding to a serial number of an item. A process in which the server queries the target item based on the serial number of the item includes: determining, by the server, a target item matching the serial number from the set of items associated with the live streaming room based on the item information that corresponds to the serial number and is carried in the item query request. The set of items includes serial numbers corresponding to a plurality of items.

Based on the embodiment described in the process 3, the item information corresponding to the serial number of the item is the serial number information of the item. Accordingly, the server queries the target item matching the serial number based on the serial number information of the item. In this embodiment, the terminal performs character identification to acquire the serial number information; and then the server performs the item matching process based on the serial number information. In this way, processing content of the server is decreased, that is, processing efficiency of the server is improved.

In the above embodiments, the terminal performs character identification to acquire the serial number information; and then the server performs the item matching process based on the serial number information. In some other embodiments, the server can perform both the character identification process and the item matching process. A corresponding process includes: performing, by the server, character identification on the serial number in the picture based on the picture that contains the serial number and is carried in the item query request; determining serial number information corresponding to the picture; and performing a subsequent process of matching an item based on the serial number information corresponding to the picture.

In this embodiment, the target item matching the serial number is acquired based on the item information corresponding to the serial number of the item, such that the target item matching the item information can be acquired fast, and efficiency of acquiring the target item is improved.

In 406, the server sends the target item to the terminal to trigger the terminal to display the target item and a post control, wherein the post control is configured to post the target item.

In some embodiments, in the case of presenting a single target item, the server returns first prompt information to the terminal, wherein the first prompt information is configured to prompt the terminal to display an item detail page of the target item, and the item detail page includes detailed information of the target item.

In some other embodiments, in the case of presenting a plurality of target items, the server returns second prompt information to the terminal, wherein the second prompt information is configured to prompt the terminal to display the plurality of target items in the form of a list.

In the above embodiments, in the case that the target item matching the item information is present, the server returns a matched target item to the terminal. In some embodiments, in the case that there's no target item matching the item information, the server returns query prompt information to the terminal. Accordingly, in the case that there's no target item matching the item information, the terminals display query prompt information in the live streaming room, wherein the query prompt information is configured to indicate that there's no target item matching the item information.

In 407, the terminal receives the target item returned by the server based on the item query request, and displays the target item and the post control.

In some embodiments, in the case of presenting a single target item, the terminal displays an item detail page of the target item, and the item detail page includes detailed information of the target item.

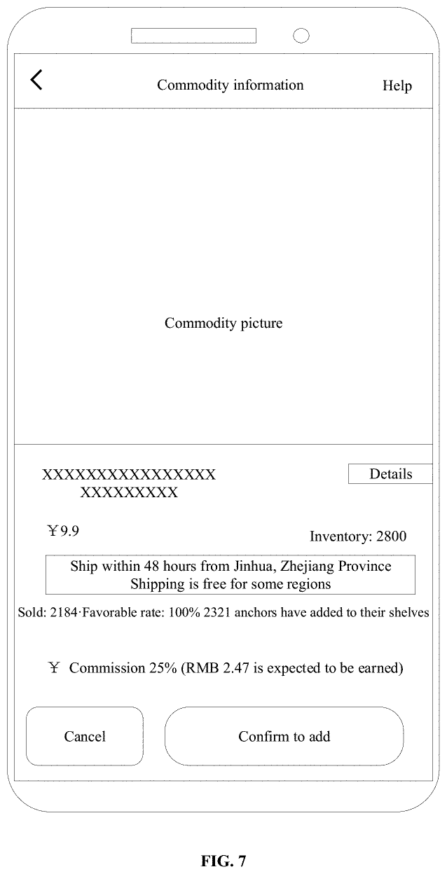

Exemplarily, FIG. 7 is a schematic diagram of an item detail page according to some embodiments of the present disclosure. Referring to FIG. 7, the item detail page is a “Commodity detail page” shown in FIG. 7. Price information, sales information, inventory information, and the like of the target item are displayed on the “Commodity detail page”. The post control is the “Confirm to add” control shown in FIG. 7. In some embodiments, the item detail page further includes a posting cancel control. Accordingly, the terminal stops displaying the item detail page in response to a trigger operation on the posting cancel control. Referring to FIG. 7, the posting cancel control is the “Cancel” control shown in FIG. 7.

In some other embodiments, in the case of presenting a plurality of target items, the terminal displays the plurality of target items in the form of a list.

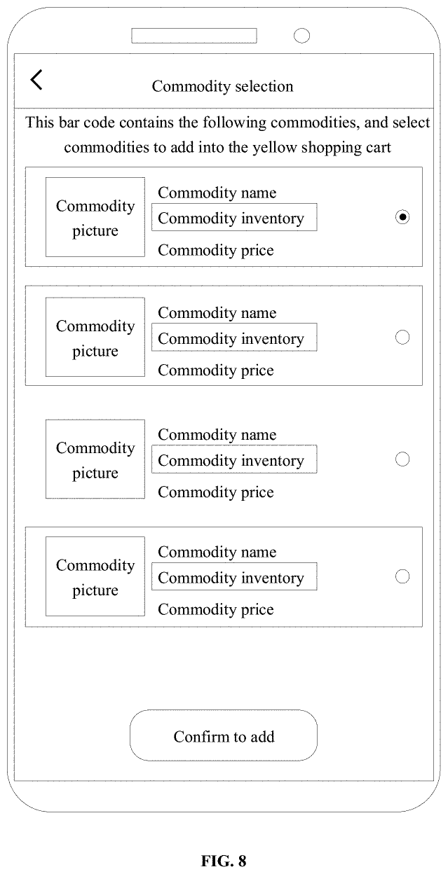

Exemplarily, FIG. 8 is a schematic diagram of displaying a plurality of target items according to some embodiments of the present disclosure. Referring to FIG. 8, on the page shown in FIG. 8, the plurality of target items acquired after matching are displayed in the form of a list. The post control is the “Confirm to add” control shown in FIG. 8.

In the above embodiments, since the number of target items is different, different displaying forms are used, such that an effect of displaying the target items is improved. A detail page containing a single target item is displayed, such that the user can view detailed information of the target item conveniently. Alternatively, a detail page containing a plurality of target items is displayed, such that the user can select an item to be posted from the plurality of target items conveniently.

In 408, the terminal sends a post request for the target item to the server in response to a trigger operation on the post control.

In some embodiments, in the case of presenting a plurality of target items, the terminal determines a selected target item in response to a select operation for at least one of the target items; and adds the selected target item into the item list of the live streaming room in response to the trigger operation on the post control. It should be understood that adding the selected target item into the item list is equivalent to adjusting the target item to be tradable. Based on this, audiences in the live streaming room can trade the target item in the live streaming room. Exemplarily, referring to FIG. 8, a plurality of select controls are displayed on the page shown in FIG. 8. One select control corresponds to one target item. In this embodiment, in the case that a plurality of target items are displayed, the user selects an item to be posted, and then the item to be posted is posted based on the post control, such that efficiency of posting the item and user's operation experience are improved.

In 409, the server adds the target item into an item list of the live streaming room in response to receiving the post request for the target item.

In 410, in the case that the target item is added successfully, the terminal jumps to the item list page of the live streaming room.

In 411, the terminal displays the target item on the item list page.

In some embodiments, the terminal displays the target item in a target region of the item list page. The target region is a fixed region in the item list page, for example, the first line of the item list page. Thus, since the target item is displayed in the target region of the item list page, a prominent displaying effect is achieved to prompt the user to view a newly posted target item.

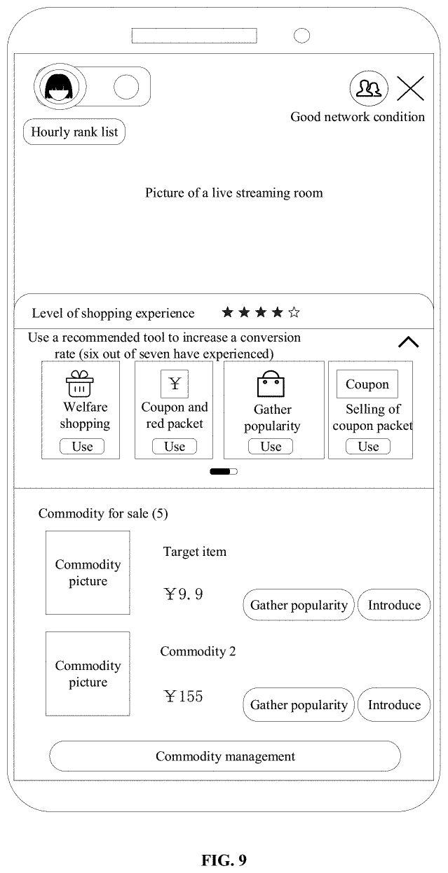

Exemplarily, FIG. 9 is a schematic diagram of an item list page according to some embodiments of the present disclosure. Referring to FIG. 9, the target item is displayed in the first line of the item list page shown in FIG. 9. In addition, in the case of presenting a plurality of target items, the plurality of target items are displayed in the first several lines of the item list page.

In the above embodiments, the terminal automatically jumps to the item list page after the target item is added successfully, and then an effect of displaying the target items on the item list page is exhibited, such that the user can view an effect of posting items conveniently, and user's operation experience is improved.

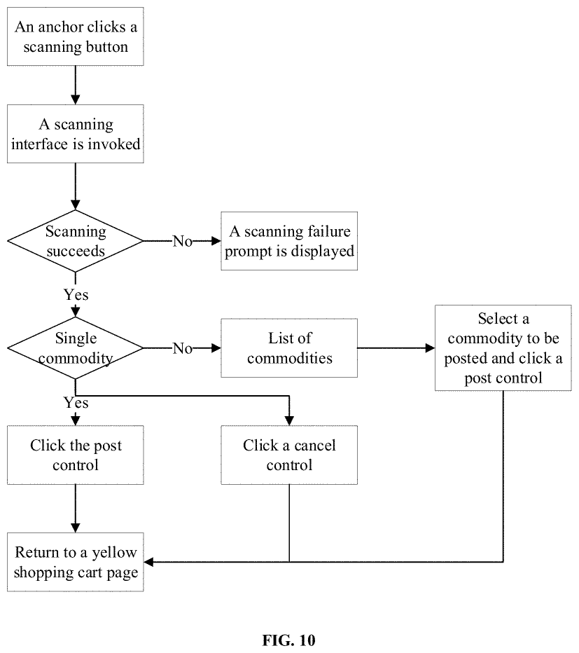

Exemplarily, FIG. 10 is a flowchart of posting an item according to some embodiments of the present disclosure. Referring to FIG. 10, for example, taking the item being a commodity as an example, a process of posting an item is described by using a graphic code as an example. A corresponding process includes: clicking, by the anchor, an item identification control provided in a yellow shopping cart page of a live streaming room to invoke a scanning interface; scanning the graphic code of the commodity through the scanning interface; and in the case that the scanning succeeds, triggering the server to query a target commodity matching the graphic code, or in the case that the scanning fails, prompting that the scanning fails. In the case that a single target commodity is acquired after querying, the terminal displays the target commodity and the post control; and the anchor can post the target commodity by clicking the post control. In the case that a plurality of target commodities are acquired after querying, the terminal displays a list of the plurality of target commodities and the post control; and the anchor can post a commodity to be posted in the live streaming room by selecting the commodity and clicking the post control. After the target commodity is posted successfully, the terminal returns to the yellow shopping cart page. In the case that the target commodity is displayed, the posting cancel control is also displayed. In the case that the anchor clicks the posting cancel control, the target commodity is not posted in the live streaming room, and the terminal returns to the yellow shopping cart page.

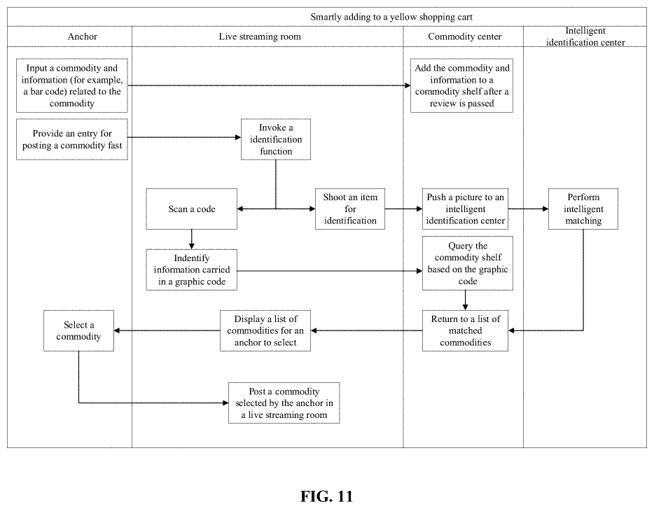

An item posting process provided in the embodiments of the present disclosure is described below with reference to FIG. 11. FIG. 11 is a flowchart of posting an item according to some embodiments of the present disclosure. Referring to FIG. 11, the server includes a commodity center server and an intelligent identification center server. Before this solution is performed, the anchor inputs a commodity and information (for example, a bar code) related to the commodity in a commodity shelf (the set of items), and sends an input request to the commodity center server. After the input request passes a review of the commodity center server, the commodity is input successfully. Then, an entry (the item identification control) for posting a commodity fast is provided in the live streaming room, and a scanning function can be triggered by clicking the entry. The information related to the commodity can be acquired by scanning a graphic code of the commodity. Then, the commodity center server queries the commodity shelf for a commodity matching the graphic code based on information contained in the graphic code. Alternatively, the anchor switches to the shooting function to acquire a commodity picture fast through shooting. Then, the commodity center server sends the commodity picture to the intelligent identification center server. The intelligent identification center server queries the commodity shelf for a commodity matching the commodity picture; and returns a matched commodity to a terminal of the anchor. For example, in the case that a plurality of matched commodities are acquired, a commodity list is returned to the terminal of the anchor for selection. Then, the anchor can post a commodity to be posted in the live streaming room by selecting the commodity and clicking the post control.

According to the technical solutions in the embodiments of the present disclosure, an item identification function is provided in a live streaming room; item information is acquired fast based on the item identification function; a server is triggered to query a matched target item based on the item information; in the case that the target item from the server is received, the target item and a post control are displayed in the live streaming room; and the target item can be added into an item list of the live streaming room fast in response to a trigger operation on the post control. According to the above method in which an item is posted fast by matching the item based on the item identification function, the terminal does not need to display all items to be posted, such that a user can query an item, thereby saving computing resources of the terminal. In addition, the user does not need to perform a plurality of page flip operations to query the item, such that an operation path for acquiring the item is shortened, and human-computer interaction efficiency and user's experience are improved.

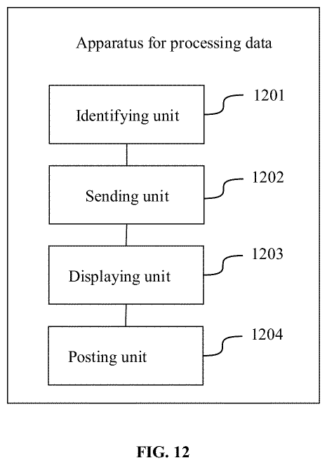

FIG. 12 is a block diagram of an apparatus for processing data according to some embodiments of the present disclosure. Referring to FIG. 12, the apparatus includes an identifying unit 1201, a sending unit 1202, a displaying unit 1203, and a posting unit 1204.

The identifying unit 1201 is configured to determine item information by identifying an item based on an item identification function provided in a live streaming room.

The sending unit 1202 is configured to send an item query request to a server based on the item information, wherein the item query request is configured to query a target item matching the item information from a set of items associated with the live streaming room.

The displaying unit 1203 is configured to receive the target item returned by the server based on the item query request, and display the target item and a post control, wherein the post control is configured to post the target item.

The posting unit 1204 is configured to add the target item into an item list of the live streaming room in response to a trigger operation on the post control.

In some embodiments, the identifying unit 1201 is configured to:

acquire item information corresponding to a graphic code of an item by scanning the graphic code at a target position based on a graphic code scanning function provided in the live streaming room;

acquire an item picture of an item by shooting the item at a target position based on a shooting function provided in the live streaming room, and acquire item information corresponding to the item picture by identifying the item picture; or

acquire a picture containing a serial number of an item by shooting the serial number at a target position based on a shooting function provided in the live streaming room, and acquire item information corresponding to the serial number by identifying the picture containing the serial number.

In some embodiments, the live streaming room includes a slide control; and

the apparatus further includes a switching unit configured to:

in the case of scanning based on the graphic code scanning function, switch the graphic code scanning function to the shooting function in response to a first slide operation on the slide control; or

in the case of shooting based on the shooting function, switch the shooting function to the graphic code scanning function in response to a second slide operation on the slide control.

In some embodiments, the displaying unit 1203 is configured to perform:

in the case of presenting a single target item, displaying an item detail page of the target item, wherein the item detail page includes detailed information of the target item; or

in the case of presenting a plurality of target items, displaying the plurality of target items in the form of a list.

In some embodiments, the posting unit 1204 is configured to:

in the case of presenting a plurality of target items, determine a selected target item in response to a select operation for at least one of the target items; and

add the selected target item into the item list of the live streaming room in response to the trigger operation on the post control.

In some embodiments, the live streaming room includes an item identification control configured to trigger the item identification function; and

the displaying unit 1203 is further configured to:

display a page provided with the item identification function in response to a trigger operation on the item identification control.

In some embodiments, the displaying unit 1203 is further configured to:

display the item identification control prominently in the live streaming room.

In some embodiments, the displaying unit 1203 is further configured to:

display the item identification control in an item list page of the live streaming room, wherein the item list page is configured to display at least one item that is traded in the live streaming room.

In some embodiments, the displaying unit 1203 is further configured to:

in the case that the target item is added successfully, jump to the item list page of the live streaming room; and

display the target item on the item list page.

In some embodiments, the displaying unit 1203 is further configured to:

display the target item in a target region of the item list page.

In some embodiments, the displaying unit 1203 is further configured to:

in the case that the item information fails to be determined based on the item identification function, display identification prompt information in the live streaming room, wherein the identification prompt information is configured to indicate identification failure;

in the case that a network fault is present, display network prompt information in the live streaming room, wherein the network prompt information is configured to prompt the network fault; or

in the case that there's no target item matching the item information, display query prompt information in the live streaming room, wherein the query prompt information is configured to indicate that there's no target item matching the item information.

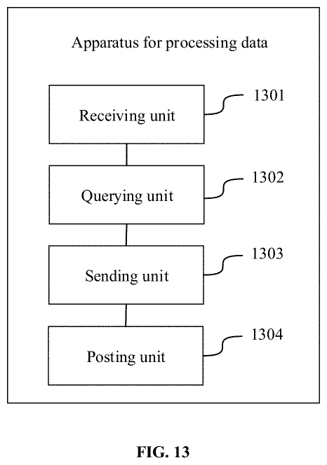

FIG. 13 is a block diagram of an apparatus for processing data according to some embodiments of the present disclosure. Referring to FIG. 13, the apparatus includes a receiving unit 1301, a querying unit 1302, a sending unit 1303, and a posting unit 1304.

The receiving unit 1301 is configured to receive an item query request sent by a terminal based on an item identification function provided in a live streaming room, wherein the item identification function is configured to determine item information based on item identification, and the item query request carries the item information;

The querying unit 1302 is configured to query, based on the item information, for a target item matching the item information from a set of items associated with the live streaming room.

The sending unit 1303 is configured to send the target item to the terminal to trigger the terminal to display the target item and a post control, wherein the post control is configured to post the target item.

The posting unit 1304 is configured to add the target item into an item list of the live streaming room in response to receiving a post request sent by the terminal for the target item, wherein the post request is sent by the terminal in response to a trigger operation on the post control.

In some embodiments, the item query request carries item information corresponding to an item picture; and

the querying unit 1302 is configured to:

determine, based on the item information that corresponds to the item picture and is carried by the item query request, a target item matching the item picture from the set of items, wherein the item set includes item pictures corresponding to a plurality of items.

In some embodiments, the querying unit 1302 is configured to:

determine a picture similarity between the item picture and each of the item pictures that correspond to the plurality of items and are contained in the set of items; and

determine an item corresponding to an item picture with the picture similarity satisfying a similarity condition as the target item.

In some embodiments, the item query request carries item information corresponding to a serial number of an item; and

the querying unit 1302 is configured to:

determine, based on the item information that corresponds to the serial number of the item and is carried in the item query request a target item matching the serial number from the set of items, wherein the set of items includes serial numbers corresponding to a plurality of items.

In some embodiments, the sending unit 1303 is further configured to:

in the case of presenting a single target item, return first prompt information to the terminal, wherein the first prompt information is configured to prompt the terminal to display an item detail page of the target item, the item detail page including detailed information of the target item; or

in the case of presenting a plurality of target items, return second prompt information to the terminal, wherein the second prompt information is configured to prompt the terminal to display the plurality of target items in the form of a list.

In some embodiments, the sending unit 1303 is further configured to:

in the case that a network fault is present, return network prompt information to the terminal, wherein the network prompt information is configured to prompt the network fault; or

in the case that there's no target item matching the item information, return query prompt information to the terminal, wherein the query prompt information is configured to indicate that there's no target item matching the item information.

It should be noted that division of all of the foregoing functional modules of the apparatus for processing data according to the embodiments of the present disclosure is described only as an example when the apparatus processes data. In practice, the foregoing functions may be completed by different functional modules as required. In other words, an internal structure of the apparatus may be divided into different functional modules to complete all or some of the functions described above. In addition, the apparatus for processing data according to the foregoing embodiment is based on the same concept as the embodiments of the method for processing data. For details about an implementation process of the apparatus, refer to the method embodiments. The details are not described herein again.

An embodiment of the present disclosure provides a computer device. The computer device includes one or more processors, and a memory for storing one or more program codes executable by the processors. The one or more program codes, when executed by the processors, cause the processors to perform the processes performed by the terminal in the above embodiments or the processes performed by the server in the above embodiments.

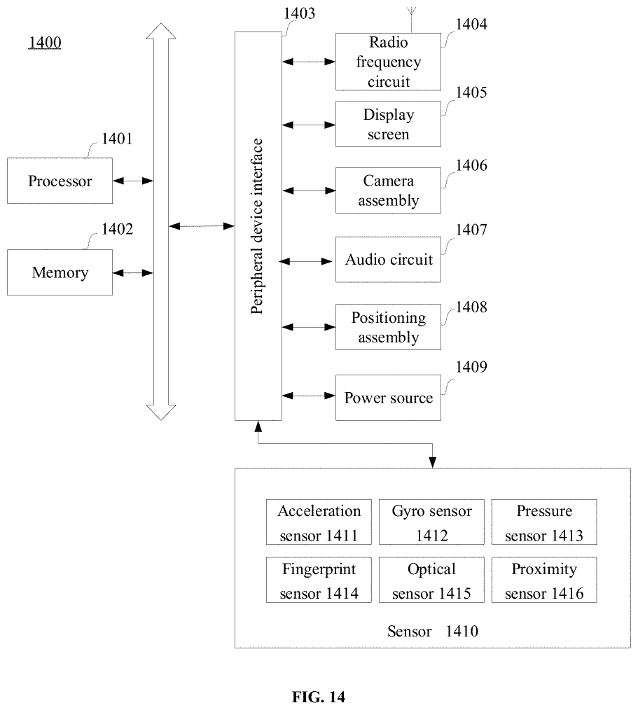

In some embodiments, the computer device in the embodiments of the present disclosure may be a terminal. FIG. 14 is a block diagram of a terminal according to some embodiments of the present disclosure. As shown in FIG. 14, the terminal 1400 is a smart phone, a tablet computer, a Moving Picture Experts Group Audio Layer III (MP3) player, a Moving Picture Experts Group Audio Layer IV (MP4) player, a notebook computer, or a desktop computer. In some embodiments, the terminal 1400 is also referred to as user equipment (UE), a portable terminal, a laptop terminal, a desktop terminal, or the like.

Generally, the terminal 1400 includes a processor 1401 and a memory 1402.

The processor 1401 may include one or more processing cores. For example, the processor 1401 may be a 4-core processor or an 8-core processor. The processor 1401 may be formed by at least one hardware of a digital signal processing (DSP), a field-programmable gate array (FPGA), and a programmable logic array (PLA). In some embodiments, the processor 1401 includes a main processor and a coprocessor. The main processor is a processor for processing the data in an awake state, and is also called a central processing unit (CPU). The coprocessor is a low-power-consumption processor for processing the data in a standby state. In some embodiments, the processor 1401 is integrated with a graphics processing unit (GPU) configured to render and draw the content that needs to be displayed by a display screen. In some embodiments, the processor 1401 further includes an artificial intelligence (AI) processor configured to process computational operations related to machine learning.

The memory 1402 includes one or more computer-readable storage mediums. In some embodiments, the computer-readable storage mediums are non-transitory. The memory 1402 further includes a high-speed random-access memory, as well as a non-volatile memory, such as one or more disk storage devices and flash storage devices. In some embodiments, the non-transitory computer-readable storage medium in the memory 1402 is configured to store at least one piece of program code. The at least one piece of program code is configured to be executed by the processor 1401 to perform the process executed by the terminal in the method for processing data provided in the method embodiments of the present disclosure.

In some embodiments, the terminal 1400 further includes a peripheral device interface 1403 and at least one peripheral device. The processor 1401, the memory 1402, and the peripheral device interface 1403 is connected by a bus or a signal line. Each peripheral device is connected to the peripheral device interface 1403 by a bus, a signal line, or a circuit board. Exemplarily, the peripheral device includes at least one of a radio frequency circuit 1404, a display screen 1405, a camera assembly 1406, an audio circuit 1407, a positioning assembly 1408, and a power source 1409.

The peripheral device interface 1403 is configured to connect at least one peripheral device associated with an input/output (I/O) to the processor 1401 and the memory 1402. In some embodiments, the processor 1401, the memory 1402, and the peripheral device interface 1403 are integrated on the same chip or circuit board. In some other embodiments, any one or two of the processor 1401, the memory 1402, and the peripheral device interface 1403 are implemented on a separate chip or circuit board, which is not limited in this embodiment of the present disclosure.

The radio frequency circuit 1404 is configured to receive and transmit a radio frequency (RF) signal, which is also referred to as an electromagnetic signal. The radio frequency circuit 1404 communicates with a communication network and other communication devices via the electromagnetic signal. The radio frequency circuit 1404 converts the electrical signal into the electromagnetic signal for transmission, or converts the received electromagnetic signal into the electrical signal. In some embodiments, the radio frequency circuit 1404 includes an antenna system, an RF transceiver, one or more amplifiers, a tuner, an oscillator, a digital signal processor, a codec chipset, a subscriber identity module card, and the like. The radio frequency circuit 1404 communicates with another terminal via at least one wireless communication protocol. The wireless communication protocol includes, but is not limited to, a metropolitan area network, generations of mobile communication networks (2G, 3G, 4G, and 5G), a wireless local area network, and/or a wireless fidelity (Wi-Fi) network. In some embodiments, the radio frequency circuit 1404 further includes near field communication (NFC) related circuits, which is not limited in the present disclosure.

The display screen 1405 is configured to display a user interface (UI). The UI includes a graph, a text, an icon, a video, and any combination thereof. In the case that the display screen 1405 is a touch display screen, the display screen 1405 further can acquire touch signals on or over the surface of the display screen 1405. The touch signal is input into the processor 1401 as a control signal for processing. In this case, the display screen 1405 is further configured to provide virtual buttons and/or a virtual keyboard, which are also referred to as soft buttons and/or a soft keyboard. In some embodiments, one display screen 1405 is disposed on the front panel of the terminal 1400. In some other embodiments, at least two display screens 1405 are disposed respectively on different surfaces of the terminal 1400 or in a folded design. In some other embodiments, the display screen 1405 is a flexible display screen disposed on the curved or folded surface of the terminal 1400. Even the display screen 1405 has an irregular shape other than a rectangle, that is, the display screen 1405 is an irregular-shaped screen. In some embodiments, the display screen 1405 is made from materials such as a liquid crystal display (LCD) and an organic light-emitting diode (OLED).

The camera assembly 1406 is configured to capture pictures or videos. In some embodiments, the camera assembly 1406 includes a front camera and a rear camera. Typically, the front camera is provided on a front panel of the terminal, and the rear camera is provided on the back of the terminal. In some embodiments, there are at least two rear cameras, each of which is any one of a primary camera, a depth-of-field camera, a wide-angle camera, and a telephoto camera, so as to achieve a bokeh effect by fusing the main camera and the depth-of-field camera, panoramic shooting and virtual reality (VR) shooting effects by fusing the main camera and the wide-angle camera, and other fusion-based shooting effect. In some embodiments, the camera assembly 1406 further includes a flashlight. The flashlight is a monochromatic-temperature flashlight or a dichromatic-temperature flashlight. The dichromatic-temperature flashlight refers to a combination of a warm-light flashlight and a cold-light flashlight, and is used to compensate light at different chromatic-temperatures.

The audio circuit 1407 includes a microphone and a speaker. The microphone is configured to collect sound waves of users and environments, and convert the sound waves into an electrical signal which is input into the processor 1401 for processing, or input into the RF circuit 1404 for voice communication. For the purpose of stereo acquisition or noise reduction, there are a plurality of microphones separately disposed at different locations of the terminal 1400. In some embodiments, the microphone is an array microphone or an omnidirectional acquisition microphone. The speaker is configured to convert the electrical signal from the processor 1401 or the radio frequency circuit 1404 into the sound waves. In some embodiments, the speaker is a conventional film speaker or a piezoelectric ceramic speaker. In the case that the speaker is the piezoelectric ceramic speaker, the electrical signal can be converted into not only human-audible sound waves but also sound waves inaudible to humans for the purpose of ranging and the like. In some embodiments, the audio circuit 1407 further includes a headphone jack.

The positioning assembly 1408 is configured to locate the current geographic location of the terminal 1400 to implement navigation or a location-based service (LBS).

The power source 1409 is configured to power up various assemblies in the terminal 1400. The power source 1409 is an alternating current, direct current, a disposable battery, or a rechargeable battery. In the case that the power source 1409 includes the rechargeable battery, the rechargeable battery is a wired rechargeable battery or a wireless rechargeable battery. The rechargeable battery also supports the fast-charging technology.

In some embodiments, the terminal 1400 further includes one or more sensors 1410. The one or more sensors 1410 include, but are not limited to an acceleration sensor 1411, a gyro sensor 1412, a pressure sensor 1413, a fingerprint sensor 1414, an optical sensor 1415, and a proximity sensor 1416.

The acceleration sensor 1411 is configured to detect magnitudes of accelerations on three coordinate axes of a coordinate system established by the terminal 1400. For example, the acceleration sensor 1411 is configured to detect components of a gravitational acceleration on the three coordinate axes. The processor 1401 controls, according to a gravity acceleration signal collected by the acceleration sensor 1411, the display screen 1405 to display a user interface in a landscape view or a portrait view. The acceleration sensor 1411 is further configured to collect motion data of a game or a user.

The gyro sensor 1412 is configured to detect a body direction and a rotation angle of the terminal 1400. The gyro sensor 1412 cooperates with the acceleration sensor 1411 to collect a 3D motion of the user on the terminal 1400. Based on the data collected by the gyro sensor 1412, the processor 1401 implements the following functions: motion sensing (such as changing the UI according to user's tilt operation), picture stabilization during shooting, game control, and inertial navigation.

The pressure sensor 1413 is disposed on a side frame of the terminal 1400 and/or a lower layer of the display screen 1405. When the pressure sensor 1413 is disposed on the side frame of the terminal 1400, user's holding signal to the terminal 1400 can be detected. The processor 1401 performs left-right hand identification or quick operation according to the holding signal collected by the pressure sensor 1413. When the pressure sensor 1413 is disposed on the lower layer of the display screen 1405, the processor 1401 controls an operable control on the UI according to user's pressure operation on the display screen 1405. The operable control includes at least one of a button control, a scroll bar control, an icon control, and a menu control.

The fingerprint sensor 1414 is configured to collect user's fingerprint. The processor 1401 identifies the user's identity based on the fingerprint collected by the fingerprint sensor 1414, or the fingerprint sensor 1414 identifies the user's identity based on the collected fingerprint. When the user's identity is identified as trusted, the processor 1401 authorizes the user to perform related sensitive operations, such as unlocking the screen, viewing encrypted information, downloading software, paying, and changing settings. The fingerprint sensor 1414 is provided on the front, the back, or a side of the terminal 1400. In the case that the terminal 1400 is provided with a physical button or a manufacturer's Logo, the fingerprint sensor 1414 is integrated with the physical button or the manufacturer's Logo.

The optical sensor 1415 is configured to acquire ambient light intensity. In one embodiment, the processor 1401 controls the display brightness of the display screen 1405 according to the ambient light intensity collected by the optical sensor 1415. Specifically, in the case that the ambient light intensity is high, the display brightness of the display screen 1405 is increased; and in the case that the ambient light intensity is low, the display brightness of the display screen 1405 is decreased. In another embodiment, the processor 1401 also dynamically adjusts shooting parameters of the camera component 1406 according to the ambient light intensity collected by the optical sensor 1415.

The proximity sensor 1416, also referred to as a distance sensor, is usually disposed on the front panel of the terminal 1400. The proximity sensor 1416 is configured to capture a distance between the user and the front of the terminal 1400. In one embodiment, in the case that the proximity sensor 1416 detects that the distance between the user and the front of the terminal 1400 gradually becomes smaller, the processor 1401 controls the display screen 1405 to switch from a screen-on state to a screen-off state. In the case that the proximity sensor 1416 detects that the distance between the user and the front of the terminal 1400 gradually becomes larger, the processor 1401 controls the display screen 1405 to switch from the screen-off state to the screen-on state.

Those skilled in the art may understand that the structure shown in FIG. 14 does not constitute a limitation to the terminal 1400. The terminal 1400 may include more or fewer components than those shown in the figure, or some components may be combined, or a different component deployment may be used.

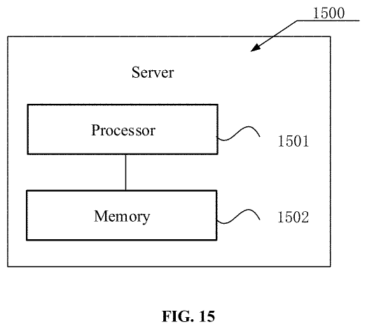

The computer device in the embodiments of the present disclosure may be a server. FIG. 15 is a block diagram of a server according to some embodiments of the present disclosure. The server 1500 may vary greatly due to different configurations or performance, and include one or more processors 1501 and one or more memories 1502. Each of the one or more memories 1502 stores at least one piece of program code. The at least one piece of program code is loaded and executed by the one or more processors 1501 to perform the processes executed by the server in the method for processing data provided in the above method embodiments. In addition, the server may further include components such as a wired or wireless network interface, a keyboard, and an input/output interface, for input and output. The server may further include other components for implementing the functions of the device, which are not described herein.

In an exemplary embodiment, a non-transitory computer-readable storage medium is further provided. In the case that one or more program codes in the non-transitory computer-readable storage medium are executed by the processor of the computer device, the computer device can perform the processes performed by the terminal in the above embodiments or the processes performed by the terminal in the above embodiments. In some embodiments, the non-transitory computer-readable storage medium may be a read-only memory (ROM), a random-access memory (RAM), a compact disc ROM (CD-ROM), a magnetic tape, a floppy disc, an optical data storage device, or the like.

In some embodiments, a computer program product is provided. The computer program product includes a computer program. In the case that the computer program is executed by the processor, the above method for processing data is performed.

In some embodiments, the computer program in the embodiments of the present disclosure may be deployed on and executed by one computer device, a plurality of computer devices at a same site, or a plurality of computer devices disposed at different sites and interconnected through a communication network. The plurality of computer devices deployed at the different sites and interconnected through the communication network may form a blockchain system.

All the embodiments of the present disclosure can be executed independently or in combination with other embodiments, which are all regarded as the protection scope required by the present disclosure.

What is claimed is:

1. A method for processing data, performed by a terminal, comprising:
determining item information by identifying an item based on an item identification function provided in a live streaming room;
sending an item query request to a server based on the item information, wherein the item query request is configured to query a target item matching the item information from a set of items associated with the live streaming room;
receiving the target item returned by the server based on the item query request;
displaying the target item and a post control, wherein the post control is configured to post the target item; and
adding the target item into an item list of the live streaming room in response to a trigger operation on the post control.

2. The method according to claim 1, wherein determining the item information by identifying the item based on the item identification function provided in the live streaming room comprises:
acquiring item information corresponding to a graphic code of an item by scanning the graphic code at a target position based on a graphic code scanning function provided in the live streaming room;
acquiring an item picture of an item by shooting the item at a target position based on a shooting function provided in the live streaming room, and acquiring item information corresponding to the item picture by identifying the item picture; or
acquiring a picture containing a serial number of an item by shooting the serial number at a target position based on a shooting function provided in the live streaming room, and acquiring item information corresponding to the serial number by identifying the picture containing the serial number.

3. The method according to claim 2, wherein the live streaming room comprises a slide control; and
the method further comprises:
in a case of scanning based on the graphic code scanning function, switching the graphic code scanning function to the shooting function in response to a first slide operation on the slide control; or
in a case of shooting based on the shooting function, switching the shooting function to the graphic code scanning function in response to a second slide operation on the slide control.

4. The method according to claim 1, wherein displaying the target item comprises:
in a case of presenting a single target item, displaying an item detail page of the target item, wherein the item detail page comprises detailed information of the target item; or
in a case of presenting a plurality of target items, displaying the plurality of target items in the form of a list.

5. The method according to claim 1, wherein adding the target item into the item list of the live streaming room in response to the trigger operation on the post control comprises:
in a case of presenting a plurality of target items, determining a selected target item in response to a select operation for at least one of the target items; and
adding the selected target item into the item list of the live streaming room in response to the trigger operation on the post control.

6. The method according to claim 1, wherein the live streaming room comprises an item identification control configured to trigger the item identification function; and the method further comprises:
displaying a page provided with the item identification function in response to a trigger operation on the item identification control.

7. The method according to claim 6, further comprising:
displaying the item identification control prominently in the live streaming room.

8. The method according to claim 6, further comprising:
displaying the item identification control in an item list page of the live streaming room, wherein the item list page is configured to display at least one item that is traded in the live streaming room.

9. The method according to claim 8, further comprising:
in a case that the target item is added successfully, jumping to the item list page of the live streaming room; and
displaying the target item on the item list page.

10. The method according to claim 9, wherein displaying the target item on the item list page comprises:
displaying the target item in a target region of the item list page.

11. The method according to claim 1, further comprising:
in a case that the item information fails to be determined based on the item identification function, displaying identification prompt information in the live streaming room, wherein the identification prompt information is configured to indicate identification failure;
in a case that a network fault is present, displaying network prompt information in the live streaming room, wherein the network prompt information is configured to prompt the network fault; or
in a case that there is no target item matching the item information, displaying query prompt information in the live streaming room, wherein the query prompt information is configured to indicate that there is no target item matching the item information.

12. A method for processing data, performed by a server, comprising:
receiving an item query request sent by a terminal based on an item identification function provided in a live streaming room, wherein the item identification function is configured to determine item information based on item identification, and the item query request carries the item information;
querying, based on the item information, a target item matching the item information from a set of items associated with the live streaming room;
sending the target item to the terminal to trigger the terminal to display the target item and a post control, wherein the post control is configured to post the target item; and
adding the target item into an item list of the live streaming room in response to receiving a post request sent by the terminal for the target item, wherein the post request is sent by the terminal in response to a trigger operation on the post control.

13. The method according to claim 12, wherein the item query request carries item information corresponding to an item picture; and
said querying, based on the item information, the target item matching the item information from the set of items associated with the live streaming room comprises:
determining, based on the item information that corresponds to the item picture and is carried by the item query request, a target item matching the item picture from the set of items, wherein the set of items comprises item pictures corresponding to a plurality of items.

14. The method according to claim 13, wherein determining, based on the item information that corresponds to the item picture and is carried by the item query request, the target item matching the item picture from the set of items comprises:
determining a picture similarity between the item picture and each of the item pictures that correspond to the plurality of items and are contained in the set of items; and
determining an item corresponding to an item picture with the picture similarity satisfying a similarity condition as the target item.

15. The method according to claim 12, wherein the item query request carries item information corresponding to a serial number of an item; and
said querying, based on the item information, the target item matching the item information from the set of items associated with the live streaming room comprises:
determining, based on the item information that corresponds to the serial number of the item and is carried in the item query request, a target item matching the serial number from the set of items, wherein the set of items comprises serial numbers corresponding to a plurality of items.

16. The method according to claim 12, further comprising:
in a case of presenting a single target item, returning first prompt information to the terminal, wherein the first prompt information is configured to prompt the terminal to display an item detail page of the target item, the item detail page comprising detailed information of the target item; or
in a case of presenting a plurality of target items, returning second prompt information to the terminal, wherein the second prompt information is configured to prompt the terminal to display the plurality of target items in the form of a list.

17. The method according to claim 12, further comprising:
in a case that a network fault is present, returning network prompt information to the terminal, wherein the network prompt information is configured to prompt the network fault; or
in a case that there is no target item matching the item information, returning query prompt information to the terminal, wherein the query prompt information is configured to indicate that there is no target item matching the item information.

18. A computer device, comprising:
one or more processors; and
a memory for storing one or more program codes executable by the one or more processors,
wherein the one or more program codes, when executed by the processors, cause the processors to perform:
determining item information by identifying an item based on an item identification function provided in a live streaming room;
sending an item query request to a server based on the item information, wherein the item query request is configured to query a target item matching the item information from a set of items associated with the live streaming room;
receiving the target item returned by the server based on the item query request, and displaying the target item and a post control, wherein the post control is configured to post the target item; and
adding the target item into an item list of the live streaming room in response to a trigger operation on the post control.

19. The computer device according to claim 18, wherein the one or more program codes, when executed by the processors, cause the processors to perform any one of:
acquiring item information corresponding to a graphic code of an item by scanning the graphic code at a target position based on a graphic code scanning function provided in the live streaming room;
acquiring an item picture of an item by shooting the item at a target position based on a shooting function provided in the live streaming room, and acquiring item information corresponding to the item picture by identifying the item picture; or
acquiring a picture containing a serial number of an item by shooting the serial number at a target position based on a shooting function provided in the live streaming room, and acquiring item information corresponding to the serial number by identifying the picture containing the serial number.

20. The computer device according to claim 19, wherein the live streaming room comprises a slide control; and
the one or more program codes, when executed by the processors, cause the processors to perform:
in a case of scanning based on the graphic code scanning function, switching the graphic code scanning function to the shooting function in response to a first slide operation on the slide control; or
in a case of shooting based on the shooting function, switching the shooting function to the graphic code scanning function in response to a second slide operation on the slide control.
